(19) United States
(12) Patent Application Publication
(10) Pub. No.: US 2014/0344167 A1
(43) Pub. Date: Nov. 20, 2014

(54) Universal Application and Reactive Communication

(71) Applicant: Bank of America Corporation, Charlotte, NC (US)

(72) Inventors: Julie Ann Kisselburg Johnson, Phoenix, AZ (US); John Kenneth Bay, Marvin, NC (US); Michael Adam, Charlotte, NC (US); George William Taylor, Charlotte, NC (US); Allison Cronin, Charlotte, NC (US)

(73) Assignee: Bank of America Corporation, Charlotte, NC (US)

(21) Appl. No.: 14/146,331

(22) Filed: Jan. 2, 2014

Related U.S. Application Data
(60) Provisional application No. 61/823,951, filed on May 16, 2013.

(51) Int. Cl. G06Q 50/18; G06Q 20/22

(52) U.S. Cl. CPC G06Q 50/188; G06Q 20/227
USPC 705/80

(57) ABSTRACT

Systems, methods, computer-readable media, and apparatuses for providing an application system that permits application for multiple products, services, accounts, and the like via one application are provided. In some examples, user input may be received and, based at least in part on the user input, recommended products, upgrades, packages, and the like, that a user may apply for that may aid in providing a benefit to the user may be communicated to the user/applicant. For instance, the recommended products, upgrades, packages and the like, may provide fee waivers, reduced fees, and/or other benefits and advantages.

### CROSS REFERENCE TO RELATED APPLICATIONS

This application claims priority to U.S. Provisional Application No. 61/823,951 (Attorney Docket No. 007131.01349) filed May 16, 2013, and entitled “Universal Application and Reactive Communication,” which is incorporated herein by reference in its entirety.

### BACKGROUND

Applying for one or more products, services and the like can be time consuming and inefficient. In particular, a small business may require a variety of products, services, accounts, and the like, in order to operate. Applying for each item individually can take time. Further, understanding the variety of options available, and the costs and fees associated with the options, can be confusing and overwhelming. Accordingly, providing a universal application that allows for application for multiple products, services, and accounts in one application may provide improved efficiency. Providing reactive feedback during the universal application process may further aid in optimizing the fee structure associated with the products, services and accounts for the customer.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for providing an application system that permits application for multiple products, services, accounts, and the like via one application. In some examples, the application system may receive user input and, based at least in part on the user input, identify recommended products, upgrades, packages, and the like, that a user may apply for that may aid in providing a benefit to the user. For instance, the recommended products, upgrades, packages and the like, may provide fee waivers, reduced fees, and/or other benefits and advantages.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates an example universal application and reactive communication system according to one or more aspects described herein.

FIG. 3 is an example method of initiating a universal application and providing reactive communication according to one or more aspects described herein.

FIG. 4 is one example user interface for initiating a universal application according to one or more aspects described herein.

FIG. 5 is another example user interface identifying an alternative offer for a user according to one or more aspects described herein.

FIG. 6 is another example user interface illustrating a universal application including acceptance of an alternative offer according to one or more aspects described herein.

FIG. 7 is an example of an alternate method of initiating a universal application and providing reactive communication according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Aspects of the arrangements described herein relate to providing a universal application system to a user that may include reactive communication. For instance, an applicant looking to open a plurality of accounts, such as, for example, a small business, may access the universal application system in order to complete an application (e.g., a single application) for all accounts. That is, the user may apply for multiple accounts, types of accounts, and the like, via one application. In some examples, during the application process, the system may communicate with the user based on received user input. For example, the system may identify a benefit for the user based on the received information (e.g., product selection, package selection, fees, and the like). This identified benefit may be communicated to the user, such as via the application user interface, and the user may determine whether to accept or decline an offer or option associated with the benefit. These and various other aspects will be described more fully below.

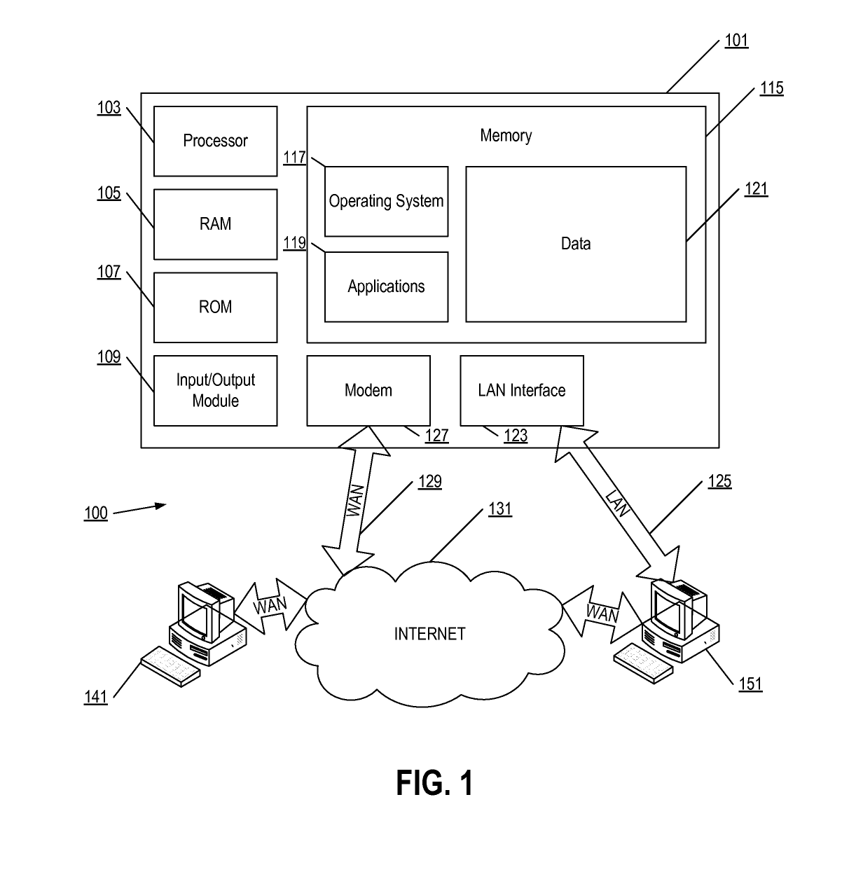

FIG. 1 illustrates an example block diagram of a generic computing device 101 (e.g., a computer server) in an example computing environment 100 that may be used in one or more illustrative embodiments of the disclosure. For example, the generic computing device 101 may correspond to a server in universal application and reactive communication system, as described in examples below. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mobile device, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1 include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, tablet computers, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

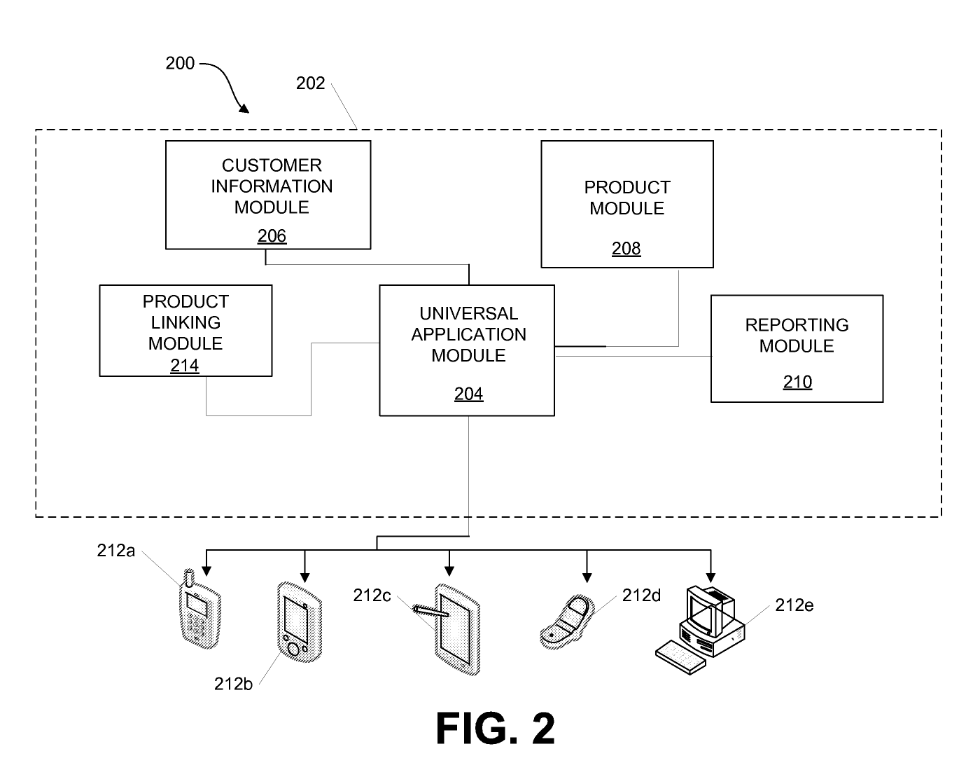

FIG. 2 illustrates one example universal application and reactive communication system according to one or more aspects described herein. In some examples, the universal application and reactive communication system 200 may be part of, internal to or associated with an entity 202. The entity may be a corporation, university, government entity, and the like. In some examples, the entity 202 may be a financial institution, such as a bank. Although various aspects of the disclosure may be described in the context of a financial institution, nothing in the disclosure shall be construed as limiting the universal application and reactive communication system to use within a financial institution. Rather, the system may be implemented by various other types of entities without departing from the invention.

The universal application and reactive communication system may include a universal application module 204. In some examples, the universal application module 204 may be in communication with one or more user devices 212a-212e, as will be discussed more fully below. The universal application module 204 may provide a user interface to a user through which a universal application may be processed and/or may receive data or information from various sources in order to process an application and/or provide reactive communication to a user during the application process. The universal application module 204 may be in communication with product linking module 214 that may process and/or link the one or more accounts, products, services, and the like, being applied for (e.g., via the universal application system). Linking of accounts, products and services will be discussed more fully below.

For example, the system 200 may include customer information module 206 that is in communication with the universal application module 204. The customer information module 206 may contain current customer information and may also receive customer information input by a user (e.g., during an application process). For instance, if a user initiates an application (whether for a universal application or a conventional application), the user may input various items of information, such as name, unique identifier, address, contact information, and the like.

The universal application and reactive communication system 200 may further include a product module 208. The product module 208 may be in communication with the universal application module 204 and may include information about one or more products or services. In some examples, the product module 208 may include one or more rules associated with various products or services.

For instance, in some examples, a user of the universal application and reactive communication system 200 may be applying for a package containing a plurality of products and/or services. In one arrangement, the user may be applying for a package of products or services for a small business. A package may include, for example, at least one checking account, at least one savings account, at least one credit card, and the like. A plurality of packages may be available for selection by a user and the different packages may include different and/or overlapping products or services and may have various advantages depending on the user. Accordingly, during the application process, a user may select a package and may also be offered an opportunity to add additional products or services during the application process. Adding these additional products or services may be completed via the universal application process such that one application may be completed in applying for multiple accounts or types of accounts (e.g., the accounts in the selected package as well as any additional products or services selected).

In some examples, the product module 208 may receive the user input received during the application process and may identify one or more rules related to the package, additional products services, fees associated with the accounts, products and/or services being applied for, and the like. These rules may identify one or more ways to optimize fees for the user (e.g., upgrade to another package to waive a fee, add another account or type of account to waive a fee associated with an account already in the package, and the like). The rules may further be used to ensure that the user is selecting the package, products and services beneficial to the user's needs, based on the received information. Accordingly, as the user moves through the application process, the product module 208 may identify one or more benefits that may be available to the user based on selection of alternative packages, products or services. These potential benefits may be communicated to the user, reactive to the user input, via a user interface, as will be discussed more fully below. The user may then have an opportunity to accept or decline the offer. Additionally or alternatively, the user may have the opportunity to revise previous selections made based on the offer communicated.

The system may further include a reporting module 210. The reporting module 210 may generate one or more reports related to user input received, offers communicated to users, acceptance rate of offers, and the like. The reporting module 210 may be accessed by various entity personnel to track the application process and the success of providing offers to users during the application process based on the information received from the user during the application process.

As mentioned above, the universal application and reactive communication system 200 may be accessed via a plurality of user devices 212a-212e. For instance, a user may access the system via smartphone 212a, a personal digital assistance 212b, a tablet computer 212c, a cell phone 212d, or a desktop or laptop computing device 212e. The user may initiate, continue, complete, and the like, an application as discussed herein, from one or more types of user devices 212a-212e. Further, personnel of the entity 202 may access the universal application and reactive communication system 200 via similar devices 212a-212e, as desired.

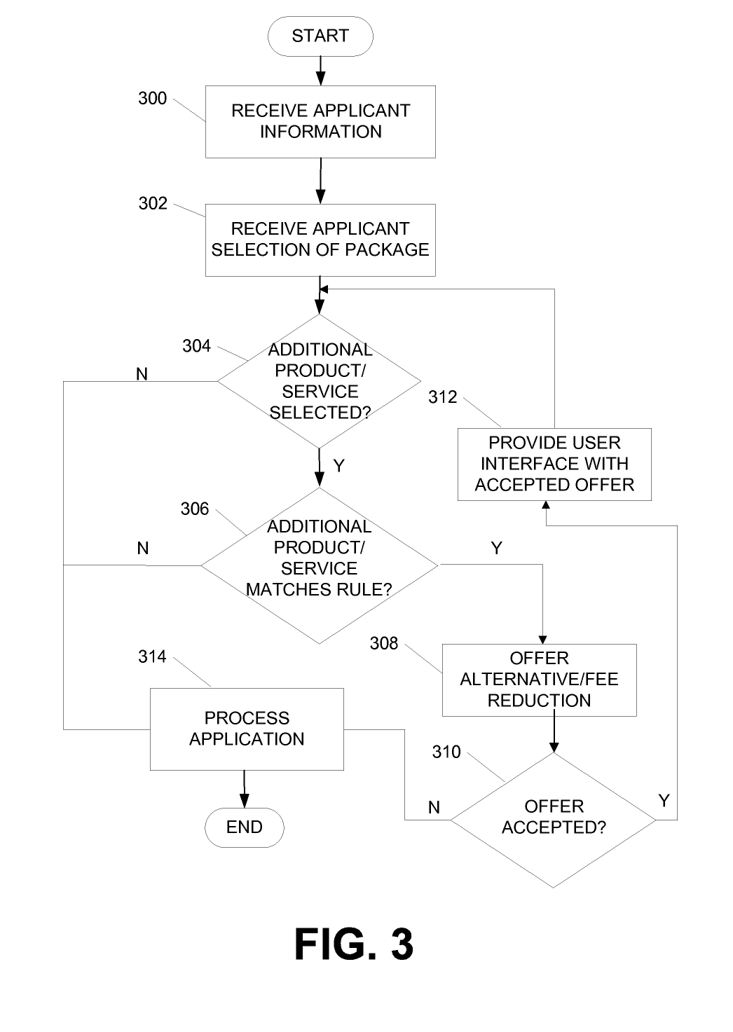

FIG. 3 illustrates one example method of processing a universal application and providing reactive communication. In step 300, user or applicant information is received. As discussed above, a user may access the universal application and reactive communication system via one or more types of user devices, including a smartphone, tablet computer, laptop computer, and the like. The system may receive applicant information, such as name, identifier, address or other contact information, and the like.

In step 302, applicant selection of a product to apply for is received. In some examples, the product applied for may be a package of products. For instance, in some examples, the product being applied for may include a plurality of accounts, products, services, and the like. The package may, in some examples, include one or more checking accounts, one or more savings accounts, one or more credit or debit cards, one or more services, one or more ways to pay, and the like. In some arrangements, a “way to pay” may include one or more ways to pay a fee associated with a product or service or to get the fee associated with the product or service waived. For example, a user may maintain a predefined balance in an account and accordingly, a fee associated with that account may be waived. In this example, maintaining the predefined balance may be considered a way to pay. Additionally or alternatively, charging a predefined threshold on a credit card or maintaining an active business service may also be considered a way to pay. For instance, if a user charges more than a predetermined threshold each month, year, and the like, a fee associated with the card, with another account linked to the card, or with the package of account, products and services, may be waived.

In some examples, the application for the products or package of products applied for may be one, universal application. That is, a user or applicant may apply for the plurality of accounts, products, services, and the like, from a single application, rather than conventional systems that may require separate applications for each account or type of account. Accordingly, the application process may be streamlined and more information may be gathered from the applicant or user in order to identify one or more benefits available to the applicant, as will be discussed more fully below.

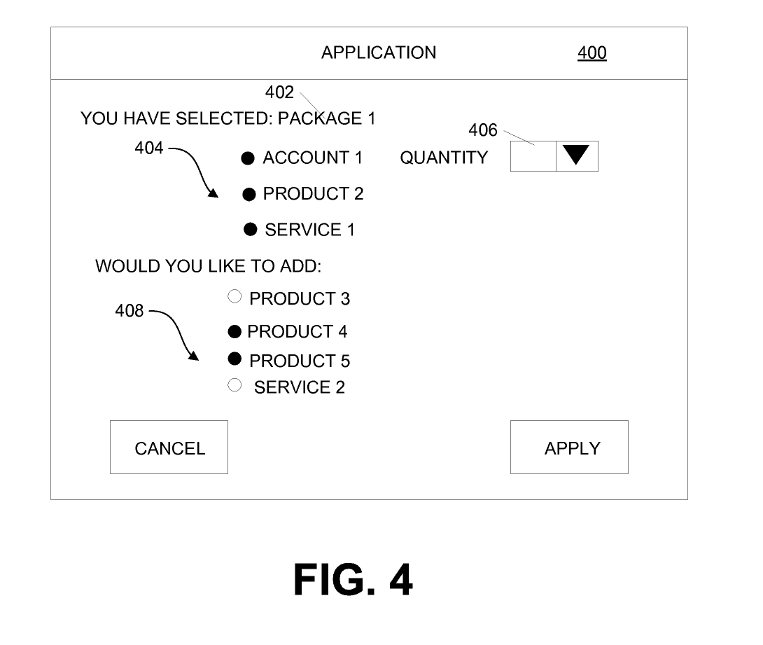

In step 304, a determination is made as to whether a selection of an additional product, service or account has received by the system. In some examples, the application process may include applying for a package of products but may also include offering a plurality of other accounts, products, services and the like, to the user or applicant during the application process. For example, FIG. 4 illustrates one example user interface 400 in which the user or applicant may apply for a package of products, services and accounts, and may also be offered a variety of other accounts, products and services to include during the application process. The package selected is indicated in field 402. Field 404 lists the products, accounts, services, and the like, that are included in the application for the selected package. In some examples, a radio button or other selection/deselection icon may be available for each item listed in field 404. Accordingly, although a package may include each item listed in field 404, a user or applicant may customize the package by deselecting one or more options, as desired. In some arrangements, the system may identify a negative effect of deselecting one or more options in field 404. For example, deselecting one account, product or service may eliminate a fee waiver, thereby reinstituting a fee associated with another account. Accordingly, the system may provide a user interface (similar to user interface 500 as described below) that will identify this potential cost increase and may provide an alternative to the user.

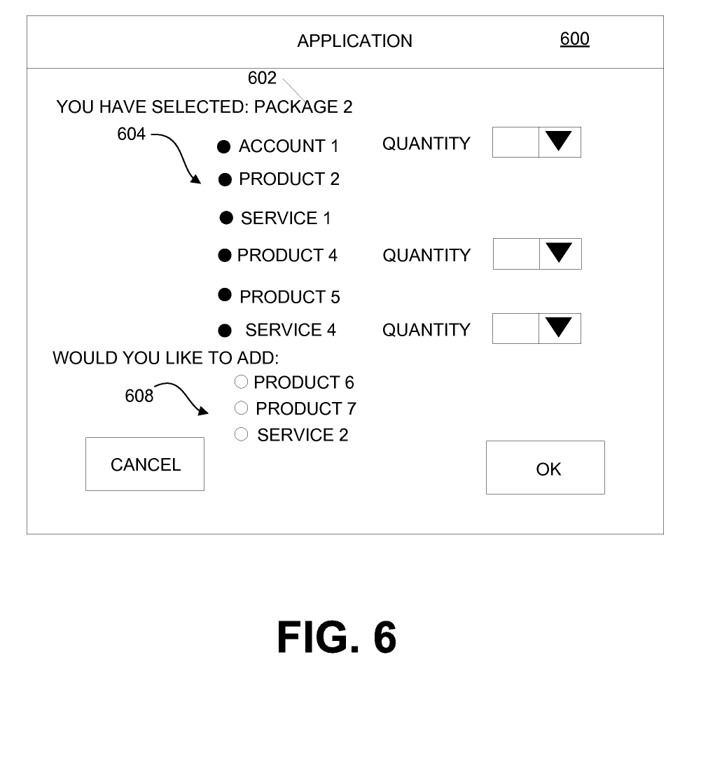

In some examples, the user interface 400 may include a quantity selection 406 for one or more of the products, accounts, services, and the like. For instance, account 1 may be a checking account. An applicant may desire to have 2 checking accounts opened with the universal application process. Accordingly, the user may select a quantity of two (2) from the drop-down menu in field 406. Although not shown in FIG. 4, other products, services, and accounts may have a quantity option associated with them. As shown in FIG. 6, some or all of the items in the package, additional items, and the like, may include an option to select a quantity. In other examples, some accounts, products, and/or services might include a quantity included in the package.

Region 408 includes a plurality of accounts, products, services, and the like that may be added to the package and applied for via the universal application process. Accordingly, an applicant may select any of the additional available products, services, accounts, and the like from field 408, as desired. Thus, with further reference to FIG. 3, in step 304, the system may determine whether a selection of one or more additional products, services, accounts, and the like, such as from field 408 in FIG. 4 has been received.

If, in step 304, a determination is made that no additional products, services or accounts have been selected, the system may proceed to process the application for the selected product or package in step 314. Alternatively, responsive to determining that selection of one or more additional, products, accounts, services and the like has been received in step 304, a determination may be made as to whether the selection, in association with other information provided and the selected package, matches or triggers a predefined rule in step 306. For instance, the system (such as system 200) may include a product module storing a plurality of rules associated with one or more packages, additional products, services, accounts, and the like. In some examples, the rules may include prohibited actions, as will be discussed more fully below. Additionally or alternatively, the rules may include rules to identify one or more benefits to a user of selecting other or additional products, services, accounts, the like, or rules to optimize any fees (e.g., minimize costs) for the applicant by selecting different products, services or accounts, by selecting a different package, by adding or removing one or more products, services or accounts, and the like.

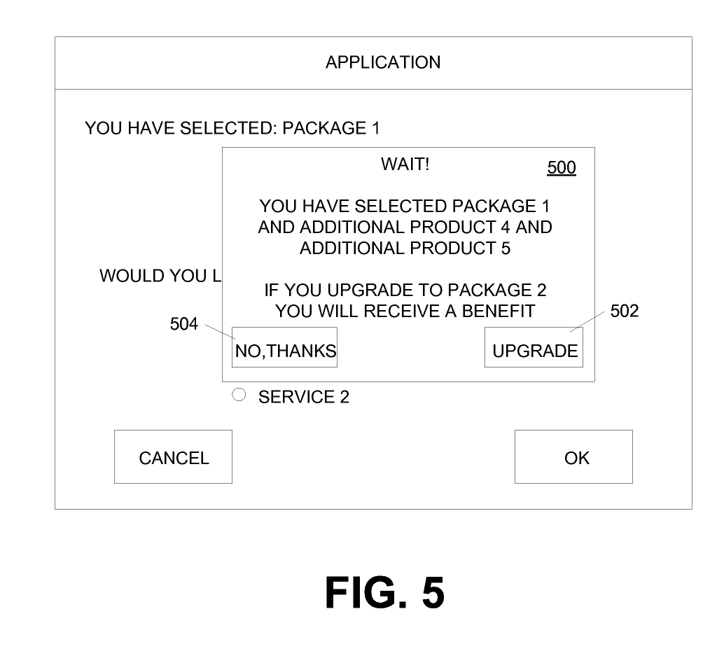

In some examples, if it is determined that a predefined rule has been triggered or matched in step 306, a second user interface may be presented to the user or applicant, offering an alternative to the user in step 308. The second user interface may, in some arrangements, overlay all or a portion of the user interface (such as interface 400) in which the user is making application selections. FIG. 5 illustrates one example second user interface 500 that may be presented to the applicant. The user interface 500 includes an indication of the previous selection (e.g., product 4 and product 5) that has matched or triggered a rule in the system, and provides an alternative (e.g., upgrade to package 2).

In some examples, the issue triggering the rule may be a potential benefit to the applicant. For example, as shown in user interface 500 of FIG. 5, the user has selected adding additional product 4 and additional product 5. In this example, the rule triggered by this selection may indicate that upgrading (e.g., to another package, such as package 2) would include product 4 and product 5 but would also provide an additional benefit to the user/applicant. In some examples, the benefit may be an additional product, account or service. Additionally or alternatively, the benefit may be a fee that may be waived. In some examples, the benefit may be a lower minimum balance for one or more accounts. Various other benefits may be implemented within the system without departing from the invention.

The user interface 500 may further include an option to accept the offer (e.g., upgrade option 502) or decline the offer (no, thanks option 504). In some examples, selection of an acceptance (502 in FIG. 2) of the offer in user interface 500 provides another user as will be discussed more fully below.

If, in step 306, the selections made (e.g., any additional products, services, accounts) do not match or trigger a rule, the application may be processed in step 314.

With further reference to FIG. 3, in step 310, a determination is made as to whether the offer has been accepted. If not, the applicant may be returned to the previous user interface to finalize and process the application, as in step 314. Alternatively, if the offer has been accepted, a user interface may be provided to the applicant in step 312 identifying the updated application information that may include selected options and/or the accepted offer. FIG. 6 includes one example user interface 600 that includes the selected options or packages and the accepted offer.

For instance, continuing the example provided above, the offer discussed in the example provides the applicant an opportunity to upgrade to package 2 in order to include the selected products (product 4 and product 5) and receive an additional benefit (as shown in interface 500). Acceptance of the upgrade may display user interface 600 which may include an identification of the package in field 602 (e.g., package 2) and may provide a list of the products, accounts, services, and the like included in the package in field 604. As shown, package 2 includes the products, accounts and services provided in package 1 as originally selected by the user. It also may include the additional products selected by the application (e.g., product 4 and product 5). Further, the package may include an additional product, service or account (e.g., service 2 in FIG. 6) that may be a benefit to the applicant.

The system may then return to step 304 to determine whether any additional products or services have been selected by the application (e.g., from the user interface 600 providing the updated application information). If additional products or services are selected, the process may continue as described above. Alternatively, if no additional products or services are selected, the application may be processed in step 314.

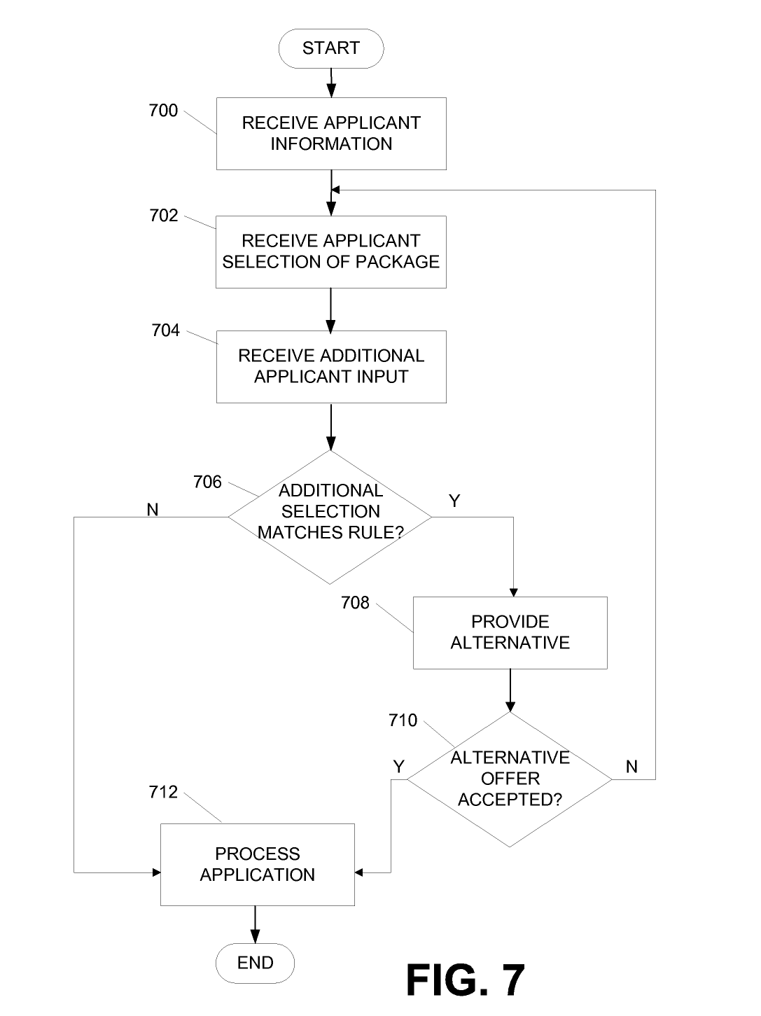

FIG. 7 provides another example method of processing a universal application and providing reactive communication according to one or more aspects described herein. In step 700, applicant or user information may be received. In step 702, a selection of a product or package being applied for may be received. Similar to the arrangement discussed above, the package may include a plurality of products, services, accounts and the like, that may be applied for using one application, rather than a separate application for each product, services or account.

In step 704, additional user or applicant input is received. In some examples, the additional user or applicant input may be selection of a quantity of a type of account, product or service (e.g., a quantity of accounts, products or services included in the package), selection of an additional account, product or service outside of those included in the package, deselection of an account, product or service included in the package, and the like. Various other types of user input may be received without departing from the invention.

In step 706 a determination is made as to whether the received additional user input triggers or matches a predefined rule. If the received additional user input does not match a predefined rule, the application will continue to processing in step 712. Alternatively, in step 706, if the received additional user input matches a rule, an alternative may be provided to the user in step 708. In some examples, the received user input may include a selection prohibited by one or more rules based on the received applicant information, package selection and the like. For example, if a package only permits up to three of a certain type of account (e.g., checking account, savings account, and the like) selection of a quantity of 4 or more of the type of account may trigger the rule. Accordingly, in step 708, an alternative may be offered to the user or applicant. For instance, a user interface similar to interface 500 may be provided that may indicate to the user that the selection is not permitted or is not advantageous (e.g., will result in increased fees, and the like). In some examples, the interface may offer an alternative (e.g., a different type of account, an upgrade to another package, and the like). In examples in which the selected user input corresponds to a prohibited action, the user may have an option to accept the offered alternative. If the user declines the offered alternative in step 710, the user may be returned to the package selection screen to continue or restart the application process.

Alternatively, if the user accepts the offered alternative in step 710, the application may continue to processing in step 712.

The universal application and reactive communication system described herein may provide a streamlined application process for a package of products, services, and accounts, and may also aid in providing beneficial products to a user while optimizing fees, costs, and the like to the user. For example, during the application process, and based on applicant information received or selections made by the applicants, the system may identify one or more products, services, and the like that may add functionality to the products included in the package being applied for and/or may reduce costs of the products for the user. For instance, the system may identify an additional product, such as payroll processing, that when added to the package, may result in a waiver of a fee associated with a product in the package or may reduce a fee associated with a product. in another example, the system may identify a service such as management of online banking that, when added to the products, services, accounts already selected by the applicant may provide additional functionality to the user and/or may result in a fee waiver or other reduction in costs to the user. The alternatives may be provided to the user/applicant during the application process in order to optimize the products, services and accounts being applied for.

The additional or alternative products, services, accounts, and the like identified by the system may be processed with the universal application. That is, in some examples, acceptance of the additional product, service or account offered by the system may be processed with the universal application rather than requiring an additional application.

Further, as discussed above, the system may identify opportunities for an applicant to upgrade to another package or product in order to receive a benefit. For example, if a user attempts to add a product, service or account to the package being applied for and that product, service or account is part of another package, the system may identify that upgrade and offer it to the applicant/user. The applicant may accept or decline such an offer, as desired.

In still other examples, the universal application process may link any accounts applied for within the universal application system. In some arrangements, some or all of the products, accounts and/or services applied for via the universal application system may be linked or associated with each other. In some examples, this linking may be performed automatically during the application and processing of the application. In other examples, some accounts, products and or services may be automatically linked while others may have additional processing in order to link them. The linking may, in some examples, be performed by a product linking module, such as module 214 in FIG. 2.

In some examples, a user may select adding a credit card to the package being applied for via the universal application system. The credit card application may not be a separate application but rather may be processed, as the other application for the other accounts products, services, concurrently with the information already submitted to the universal application system. In some arrangements, the credit card may also be linked to the other accounts, products or services applied for via the universal application system.

Further, because multiple products, services, and accounts are being applied for in one application, the system may receive more robust information about the products, services, and accounts desired by the applicant which can aid in identifying one or more alternatives to offer.

The various features and aspects of the universal application and reactive communication system described herein aid in streamlining the application process and aid in ensuring that applicants and users maximize the products, services and accounts available to them. In addition, various other aspects of the system may be configured to streamline the application process. For example, an e-signature may be used when completing the application, thereby reducing or eliminating the need for generating additional paperwork, traveling to a financial institution, and the like.

The number, type and the like of products accounts services, is merely one example. More or fewer accounts, products, services and/or more or fewer types of accounts, products, services may be provided without departing from the invention.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive user input selecting a package for which an applicant is applying, the package including a plurality of products;
receive user input selecting an additional product to which the applicant is applying;
determine, by the apparatus, that the selected package matches a predefined rule;
responsive to determining that the selected package matches a predefined rule, identify an offer to propose to the user during the application process based, at least in part, on the predefined rule; and
receive user input accepting or declining the offer proposed during the application.

2. The apparatus of claim 1, wherein the plurality of products includes a plurality of different types of accounts.

3. The apparatus of claim 2, wherein the plurality of different types of accounts includes at least one checking account and at least one savings account.

4. The apparatus of claim 1, wherein determining that the selected package matches a predefined rule is responsive to the received user input selecting the package and the received user input selecting the additional product.

5. The apparatus of claim 4, wherein the predefined rule includes a negative effect and the offer includes an offer to apply for an alternate package different from the selected package that includes a benefit.

6. The apparatus of claim 5, wherein the predefined rule includes reinstitution of a fee and the offer includes an offer to apply for an alternate package that does not include the fee.

7. The apparatus of claim 1, wherein the package is a package of products and the additional product is an additional type of an account that is part of the package.

8. A method, comprising:
receiving user input selecting a package for which an applicant is applying, the package including a plurality of products;
receiving user input selecting an additional product to apply for;
determining, by the apparatus, that the selected package matches a predefined rule;
responsive to determining that the selected package matches a predefined rule, identifying an offer to propose to the user during the application process; and
receiving user input accepting or declining the offer proposed during the application.

9. The method of claim 8, wherein the plurality of products includes a plurality of different types of accounts.

10. The method of claim 9, wherein the plurality of different types of accounts includes at least one checking account and at least one savings account.

11. The method of claim 8, wherein determining that the selected package matches a predefined rule is responsive to the received user input selecting the package and the received user input selecting the additional product.

12. The method of claim 11, wherein the predefined rule includes a negative effect and the offer includes an offer to apply for an alternate package different from the selected package that includes a benefit.

13. The method of claim 12, wherein the predefined rule includes reinstitution of a fee and the offer includes an offer to apply for an alternate package that does not include the fee.

14. The method of claim 8, wherein the package is a package of products and the additional product is an additional type of an account that is part of the package.

15. One or more non-transitory computer-readable media having computer-executable instructions stored thereon that, when executed, cause at least one computing device to:
receive user input selecting a product an applicant is applying for, the product including a plurality of products;
receive user input selecting an additional product to apply for;
determining, by the apparatus, that the selected product matches a predefined rule;
responsive to determining that the selected product matches a predefined rule, identifying an offer to propose to the user during the application process; and
receiving user input accepting or declining the offer proposed during the application.

16. The one or more non-transitory computer-readable media of claim 15, wherein the plurality of products includes a plurality of different types of accounts.

17. The one or more non-transitory computer-readable media of claim 16, wherein the plurality of different types of accounts includes at least one checking account and at least one savings account.

18. The one or more non-transitory computer-readable media of claim 15, wherein determining that the selected package matches a predefined rule is responsive to the received user input selecting the package and the received user input selecting the additional product.

19. The one or more non-transitory computer-readable media of claim 18, wherein the predefined rule includes a negative effect and the offer includes an offer to apply for an alternate package different from the selected package that includes a benefit.

20. The one or more non-transitory computer-readable media of claim 19, wherein the predefined rule includes reinstitution of a fee and the offer includes an offer to apply for an alternate package that does not include the fee.

21. The one or more non-transitory computer-readable media of claim 15, wherein the package is a package of products and the additional product is an additional type of an account that is part of the package.
